(19) United States
(12) Patent Application Publication
(10) Pub. No.: US 2026/0162335 A1
(43) Pub. Date: Jun. 11, 2026

(54) METHODS AND SYSTEMS FOR GENERATIVE VIDEO PROPAGATION

(71) Applicant: Adobe Inc., San Jose, CA (US)

(72) Inventors: Soo Ye Kim, Los Angeles, CA (US); Zhifei Zhang, San Jose, CA (US); Zhe Lin, Clyde Hill, WA (US); Yijun Li, Seattle, WA (US); Tianyu Wang, Mountain View, CA (US); Shaoteng Liu, Ma Liu Shui (HK); Qing Liu, Santa Clara, CA (US); Jui-hsien Wang, Sammamish, WA (US); Joon-Young Lee, San Jose, CA (US)

(21) Appl. No.: 19/387,238

(22) Filed: Nov. 12, 2025

Related U.S. Application Data
(60) Provisional application No. 63/730,770, filed on Dec. 11, 2024.

(51) Int. Cl. G06T 11/60; G06N 3/04

(52) U.S. Cl. CPC G06T 11/60; G06N 3/04

(57) ABSTRACT

A media generation system propagates editing process through frames of a media segment. The media generation system receives a sequence of frames. The media generation system also receives a first subset of frames that correspond to edited representations of one or more frames of the sequence of frames. The media generation system uses a selective content encoder to identify features of the first subset of frames that are unmodified by the editing process. The media generation system then executes a image-to-video model using the sequence of frames and the features of the first subset of frames. The image-to-video model propagates the edits applied to the one or more frames to the frames of the sequence of frames. The media generation system then outputs an edited representation of the sequence of frames.

### CROSS-REFERENCE TO RELATED APPLICATIONS

The present patent application claims the benefit of priority to U.S. Provisional Patent Application No. 63/730,770 filed Dec. 12, 2024, which is incorporated herein by reference in its entirety for all purposes.

### TECHNICAL FIELD

This disclosure relates to editing media, and more particularly to artificial-intelligence techniques for propagating editing operations through frames of media segments.

### BACKGROUND

Media generation can be an iterative and resource intensive process. For example, some media generation techniques include capture multiple versions of the media because the desired version of the media may be unknown until captured. Then the media may be subject to various editing operations where the media may be iteratively modified. For instance, the editing operations may include adding or removing frames, combining media, adding effects, modifying pixel coloring, modifying color saturation, adjusting contrast, etc. If a particular representation of the media is not available during editing, then the process may return to the capturing phase where additional representations of the media may be captured. This iterative process between capturing and editing continues until a desired media is generated.

### SUMMARY

Methods and systems are described herein for generative media propagation. A media generation system receives a media segment comprising a set of frames. The set of frames include video frames and/or audio frames (e.g., audio segments, etc.). In some examples, the media generation system receives an edited representation of at least one frame of the set of frames. The edited representation of the at least one frame may include modified data as a result of an editing process that added or removed content of the frame, modified pixels, etc. In other examples, the media generation system executes the editing process to modify the at least one frame.

The media generation system uses a selective content encoder to identify portions of the at least one frame modified by the editing process. For example, the selective content encoder compares the at least one frame with the remaining frames of the set of frames to identify the modified portions of the at least one frame. For example, a user edits a frame to remove an object from the frame. The selective content encoder compares the edited frame with the remaining frames of the media segment to identify pixels of the at least one frame that have been modified. The selective content encoder then defines an image mask for the remaining frames. The image mask includes a prediction of portions of the remaining frames that would be modified if the editing process is applied to the remaining frames. For example, if a first frame is edited to remove an object, the selective content encoder generates an image mask for each of the remaining frames that predict the portion of each remaining that correspond to the removed object.

The media generation system executes an image-to-video (I2V) model using the media segment, the at least one frame, and the image masks from the selective content encoder. The I2V model propagates the editing process to the remaining frames of the set of frames by, for example, generating a representation of each remaining frame based on the editing process. For example, if the editing process removes an object from the at least one frame, the I2V model generate a representation of the remaining frames with the object removed. In some examples, the I2V model may be further guided using a context vector that indicates a context of the editing process on the media segment. For example, the context vector may be an alphanumeric prompt provide that indicates an intent of the editing process. The media generation system then outputs the edited media segment.

The methods, systems, and non-transitory computer-readable media and systems described herein include various media editing systems and operations as previously described.

These illustrative examples are mentioned not to limit or define the disclosure, but to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 illustrates a block diagram of an example media generation system according to aspects of the present disclosure.

FIG. 2 illustrates example inputs and outputs of a media generation system propagating an editing operation through a media segment according to aspects of the present disclosure.

FIG. 3 illustrates an example attention map visualization of a media generation system according to aspects of the present disclosure.

FIG. 4 illustrates an example block diagram of training a media generation system according to aspects of the present disclosure.

FIG. 5 illustrates an example implementation of region-aware loss within a selective content encoder of a media generation system according to aspects of the present disclosure.

FIG. 6 illustrates a flowchart of an example process for interpolating keyframes to generate interpolated animation frames according to aspects of the present disclosure.

FIG. 7 shows an example of a guided diffusion model according to aspects of the present disclosure.

FIG. 8 shows an example of a U-Net according to aspects of the present disclosure.

FIG. 9 shows an example of a method for conditional media generation according to aspects of the present disclosure.

FIG. 10 shows a diffusion process according to aspects of the present disclosure.

FIG. 11 shows a flow diagram depicting an algorithm as a step-by-step procedure for training a machine-learning model according to aspects of the present disclosure.

FIG. 12 shows an example of a method for training a diffusion model according to aspects of the present disclosure.

FIG. 13 shows an example of a computing device according to aspects of the present disclosure.

FIG. 14 shows an example of a media generation system apparatus according to aspects of the present disclosure.

### DETAILED DESCRIPTION

Methods and systems are described herein for generative media propagation. While there are conventional techniques for generating or modifying media segments, the conventional techniques use models trained to generate particular types of modifications. These models are prone to error accumulation, leading to limited robustness and generalization ability. For example, introducing an error when modifying a first frame of media segment introduces the error into subsequent frames of the media segment. Furthermore, the conventional techniques focus on limited types of tasks at the expense of general applicability leading to the training of individual models that perform a singular task or modification. Such models are unable to perform other, even similar, tasks or modifications. Thus, the conventional techniques rely on a time consuming and resource intensive operations of training multiple models to perform varying operations.

The methods and systems described herein include improved techniques for generating and modifying media segments through generative media propagation. A media generation system includes a selective content encoder that operates with an image-to-video model (I2V) to propagate modifications made to one or frames of a video segment to remaining frames of the video segment. The media generation system trains the selective content encoder to generate image masks associated with editing processes (e.g., modifications to frames of media segments). The image masks predict an area of a frame that would be edited if the editing process is applied to the frame. The image masks constrain the generative processes of the I2V model, reducing errors and error propagation through the generative process. In addition, the selective content encoder guiding the generative process of the I2V model reduces the training complexity of the I2V model. In some examples, the I2V model may be a generally trained I2V model (e.g., trained on arbitrary image/video datasets). Thus, the media generation system accurately propagates editing process through media segments without specialization of the I2V model, which reduces the time and complexity of instantiating the media generation system.

A media generation system includes hardware and/or software for generating media segments. In some implementations, the media generation system operates as software executing on a computing device or server. In other implementations, the media generation system operates as a hardware platform (e.g., such as an application specific integrated circuit (ASIC), field-programmable gate array (FPGA), special-purpose computer, and/or the like). In still yet other implementations, the media generation system operates as combination of software and hardware. In some examples, the media generation system operates within a distributed environment via one or more computing devices, databases, servers, etc. A user operates media generation system directly (e.g., via an input interface of the media generation system or via a computing device executing the animation system, etc.). Alternatively, or additionally, the user accesses the animation system remotely via a computing device through interfaces exposed by media generation system.

The media generation system includes a selective content encoder and an I2V model. The selective model encoder is a machine-learning model that encodes features of a frame for the I2V model. The I2V model is a generative machine-learning model trained to generate video from images. The media generation system is trained to propagate editing processes to frames of media segments. For example, a user edits one or more frames of a media segment. The media generation system then propagates the edits from the one or more frames through the rest of the frames of the media segment generating an edited media segment. The media generation system propagates various editing processes such as, but not limited to, adding an object, removing an object, modifying a background, adding effects, color correction, object tracking (e.g., modifying pixels associated with a particular object, etc.), combinations thereof, and/or the like.

The media generation system receives a media segment including a set of frames. In some examples, the set of frames includes an edited representation of at least one frame. Alternatively, a user of the media generation system edits the at least one frame. The selective content encoder selectively encodes features of the frames of the media segment. In some examples, the selective model encoder encodes the features of the unchanged parts of the frames (e.g., the portions of the frames that are not subject to an editing process) based on a comparison of an edited frame to the remaining frames of the media segment. The selective content encoder does not encode features in portions of frames edited by the editing process or to be edited by propagation of the editing process to the remaining frames. The output of the selective content encoder is an image mask that indicates the regions of a frame that should not be altered by propagation of the editing process. In other instances, the selective model encoder encodes the features of the modified parts of the frames (e.g., the portions of the frames that are subject to an editing process). In those instances, the selective content encoder does not encode features in portions of frames that are not impacted by the editing process or will not be impacted by propagation of the editing process. The output of the selective content encoder is an image mask that indicates the regions of a frame that should be altered by propagation of the editing process

The I2V model receives the encoded features of the selective content encoder and the frames of the media segment. In some instances, the I2V model also receives a context vector corresponding to an alphanumeric prompt that provides context on the editing process being propagated. The I2V model propagates the edits applied to the at least one frame to the non-encoded regions of the remaining frames. If the I2V model receives a context vector, then the I2V model uses the context vector to constrain the generative process.

The media generation system facilitates an output of the edited media segment. In some examples, the media generation system stores the edited media segment in memory for further processing (e.g., such as further editing, transmission, display, etc.). For example, the media generation system receives feedback associated with the edited media segment causing the media generation system to propagate the feedback through the edited media segment generating a new edited media segment. The feedback may be related to the initial editing process to adjust the initial editing process or propagation of the initial editing process through the media segment or related to a new editing process (e.g., a newly edited frame, etc.). In other instances, the media generation system transmits the edited media segment to remote device (e.g., such as a client device, server, database, webhost, etc.).

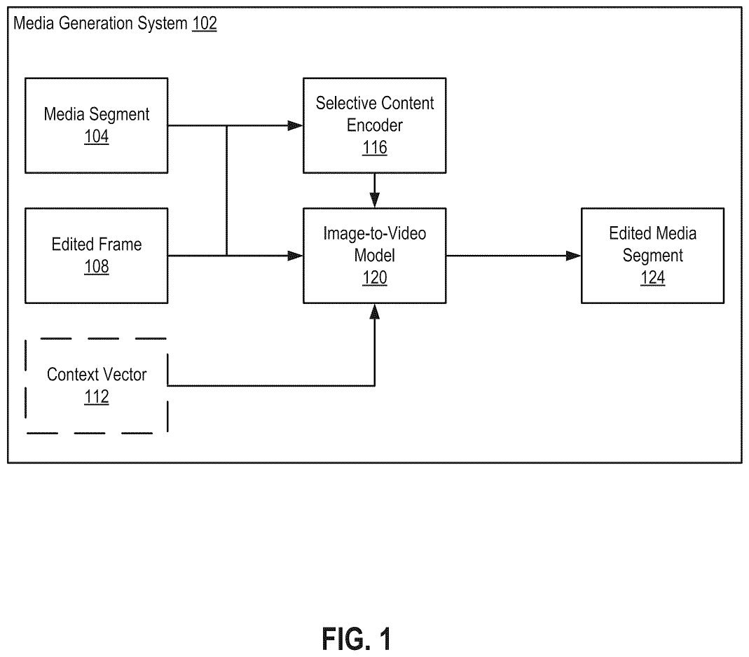

FIG. 1 illustrates a block diagram of an example media generation system according to aspects of the present disclosure. Media generation system 102 includes a multi-model process for propagating changes applied to a frame of a media segment to subsequent frames of the media segment. Media generation system 102 receives media segment 104 that includes a sequence of frames. For example, media generation system 102 receive media segment 104 from an input interface (e.g., such an input/output interface, network interface, and/or the like). In some instances, media generation system 102 also receive an edited representation of one or more frames 108 of the sequence of frames. In other instances, media generation system 102 executes one or more editing processes on the one or more frames to generate the edited representation of the one or more frames 108. Examples of editing processes include, but not limited to, adding an object, removing an object, modifying a background, adding effects, color correction, object tracking (e.g., modifying pixels associated with a particular object, etc.), combinations thereof, and/or the like.

Media generation system 102 passes the media segment 104 and the edited representation of the one or more frames 108 to selective content encoder 116. Selective content encoder 116 encodes features of frames. Selective content encoder 116 uses a region-aware loss to retain features of the unchanged portion of the edited representation of the one or more frames 108. The selective content encoder 116 then predicts a portion of each frame in the sequence of frames that would remain unchanged if the one or more editing processes were applied to the frame. In some instances, the selective content encoder 116 outputs an image mask for each frame that indicates the portions of the frame that should remain unmodified. In other instances, the selective content encoder 116 outputs an image mask for each frame that indicates the portions of the frame that should be modified by the editing process.

Media generation system 102 passes the media segment 104, the edited representation of the one or more frames 108, and the image masks to image-to-video model 120. In some instances, image-to-video model 120 also receives context vector 112. Context vector 112 may be a prompt (e.g., an alphanumeric input) that provide context of how the generative process of the image-to-video model 120 should be applied to the media segment. Context vector 112 operates as a constraint that limits the generative process of the image-to-video model. Image-to-video model 120 uses the image masks to propagate the editing process to the remaining frames of the media segment generating an edited representation of the media segment 124.

Media generation system 102 outputs the edited representation of the media segment 124. In some instances, media generation system 102 transmits the edited representation of the media segment 124 to the device that transmitted the media segment 104 to media generation system 102. In other instances, media generation system 102 transmits the edited representation of the media segment 124 to a storage device (e.g., local or remote memory, etc.) or to a device for presentation (e.g., such as a display device, etc.).

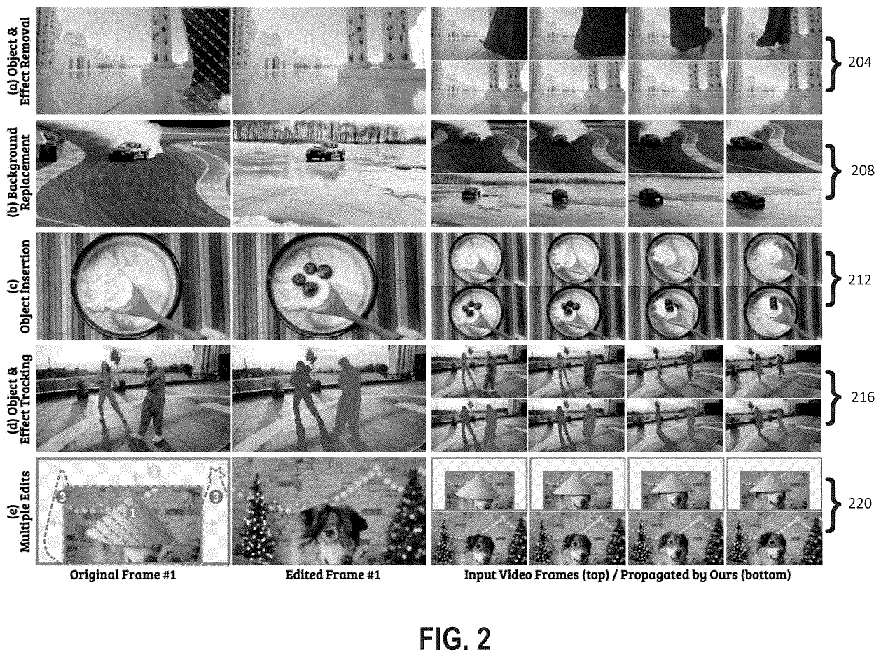

FIG. 2 illustrates example inputs and outputs of a media generation system propagating an editing operation through a media segment according to aspects of the present disclosure. A Media generation system propagates changes to a frame to the remaining frames of a media segment while keeping other parts of the remaining frames consistent with the media segment. The media generation system can propagate various editing processes such as, but not limited to, object removal, object insertion, object and/or background replacement, text-based editing, outpainting, object tracking, combinations thereof, and/or the like. For example, images 204 illustrate an object removal where legs can be seen in a first frame of a media segment. The media generation system receives an edited representation of the first frame with the legs removed. The media generation system then propagates those changes by removing the legs in the remaining frames regardless of the location within the frame, size of the legs, shape of the legs, etc. The upper images of images 204 illustrate the original frames and the lower images represent the edited representation of the frames output by the media generation system.

Images 208 illustrate a background replacement where the background of a vehicle drifting on a racetrack is edited to replace the racetrack with ice. The media generation system receives an edited representation of the first frame with the ice background and removing the smoke. The media generation system then propagates those changes by replacing the background in the remaining frames regardless of where the care appears within the frame. The upper images of images 208 illustrate the original frames and the lower images represent the edited representation of the frames output by the media generation system.

Images 212 illustrate an object insertion where blueberries are added to oatmeal. The media generation system receives an edited representation of the first frame with the blueberries. The media generation system then propagates those changes by adding the blueberries to the remaining frames. The image-to-video model generates additional inferences to improve generated images. For example, blueberries are systematically removed as the media segment progress to simulate someone eating the generated blueberries. The upper images of images 212 illustrate the original frames and the lower images represent the edited representation of the frames output by the media generation system.

Images 216 illustrate an object tracking where pixels representing an object or background or tacked through the media segment. The media generation system receives an edited representation of the first frame with the pixels corresponding to a tracked object altered. The media generation system then propagates those changes by modifying the pixels corresponding to the tracked object in remaining frames. The media generation system is capable of tracking multiple different objects simultaneously. The upper images of images 216 illustrate the original frames and the lower images represent the edited representation of the frames output by the media generation system.

Images 220 illustrate a multi edit implementation where the media generation system propagates multiple different edits to a frame at once such as increasing a background, adding objects, removing a hat, etc. as shown. The upper images of images 216 illustrate the original frames and the lower images represent the edited representation of the frames output by the media generation system.

The media generation system includes improved inferencing for implementing 1) substantial shape modification in object editing tasks, 2) simulating independent motion of inserted objects in insertion tasks, (3) removal of object effects like shadows and reflections in removal tasks, (4) accurate tracking of objects along with their associated effects, etc.

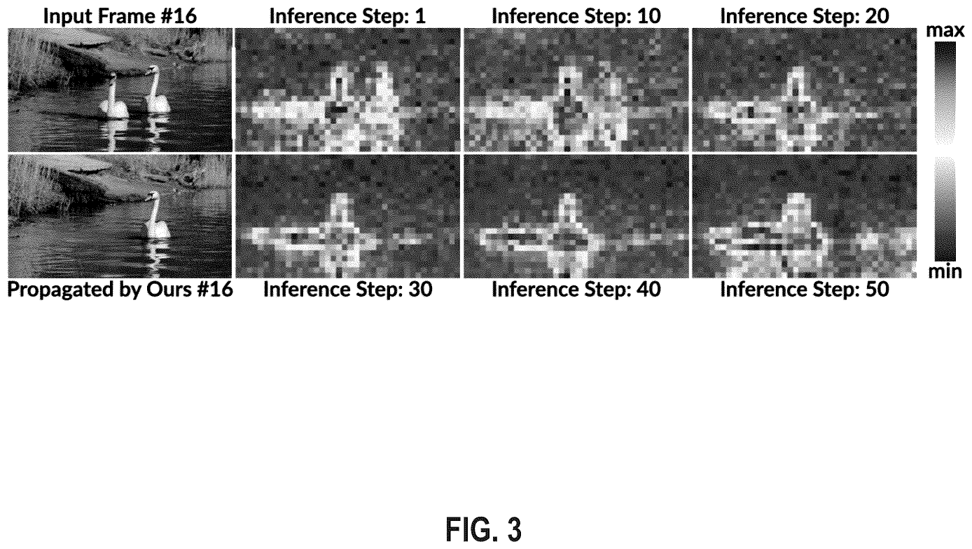

FIG. 3 illustrates an example attention map visualization of a media generation system according to aspects of the present disclosure. The model architecture of the media generation system includes a Selective Content Encoder (SCE) that encodes the information of the original video, and an I2V generation model that uses the edited frame for propagation. The media generation system trains the SCE to selectively encode features of the unchanged parts of frames of the media segment, while preserving the generation capabilities of I2V models to propagate the altered parts to subsequent frames. The media generation system implements a region-aware loss and applies adjusted to gradients within the modified region to reduce a likelihood that the SCE will encode features in the modified parts of frames. In some instances, the media generation system trains the SCE using synthetic data derived from video instance segmentation datasets. For example, the attention maps of FIG. 3 illustrate weighted gradients indicating the parts of a frame that can be modified (e.g., the red region) and the parts of frames that should remain unmodified (e.g., blue region). The input frame includes a representation of two swans with editing process intending to modify the swans. The attention map illustrates the SCE identifying the pixels corresponding to the swans as well as the impact of the swans in the environment (e.g., water wake, etc.). In some instances, the media generation system uses an auxiliary decoder head during training to predict the modified region (e.g., for feedback-based learning algorithms such as reinforcement learning and/or for accuracy metrics, etc.).

Given an input media segment V={v₁, v₂, . . . , v_{T}} with T frames, let

$${v}_{1}^{′}$$

denote a modified frame. The modified frame,

$${v}_{1}^{′}$$

may be the first frame in the sequence of frames or may be any arbitrary frame within the sequence. The media generation propagates the edits applied to the modified frame to the frames positioned after the modified frame within the sequence V.

The media generation system propagates the modifications to

$${v}_{1}^{′}$$

to V, producing a modified video

$$V = \{ {v}_{1}^{′} , {v}_{2}^{′} , … , {v}_{T}^{′} \} ,$$

where each frame

$${v}_{t}^{′}$$

(for t=2, . . . , T) retains the modification applied to the

$${v}_{1}^{′} ,$$

while maintaining consistency in both appearance and motion throughout the sequence. The media generation system includes a latent diffusion model that encodes pixel information in a latent space (e.g., where vₜ refers to the latent representation). During inference, the media generation system refers to each frame

$${v}_{t}^{′}$$

as:

$${v}_{t}^{′} = 𝒢 ( ℰ ( V ) , {v}_{1}^{′} , t ) ,$$

∀t∈{2, . . . , T}, where [symbol] is the I2V generation model guided by the selective content encoder (SCE), ε(V).

In some examples, the media generation system uses synthetic data constructed from existing video instance segmentation datasets to create paired samples. A data generation operator [symbol] , constructs training data pairs (vᵢ,\hat{v}ᵢ) from an original media segment V. [symbol] (V) represents the synthetic data generation operator applied to the original video sequence, where: (vᵢ,\hat{v}ᵢ)∈ [symbol] (V), ∀i∈{1, . . . , T} and \hat{V}={\hat{v}₁, \hat{v}₂, . . . , \hat{v}_{T}} represents the synthetic video sequence. The media generation system is trained to satisfy

$${min}_{ℰ} {\sum }_{i = 2}^{T} ℒ ( 𝒢 ( ℰ ( \hat{V} ) , {v}_{1} , i ) , {v}_{i} )$$

across all frames i∈{2, . . . , T}, where [symbol] is a region-aware loss designed to disentangle the modified and unmodified regions, enforcing stability in the unchanged areas while allowing for accurate propagation in the modified regions. To ensure that the final output adheres to real media segment data distributions, synthetic data is fed exclusively to the content encoder. The I2V generation model, however, uses the original video, preventing the model from inadvertently learning synthetic artifacts.

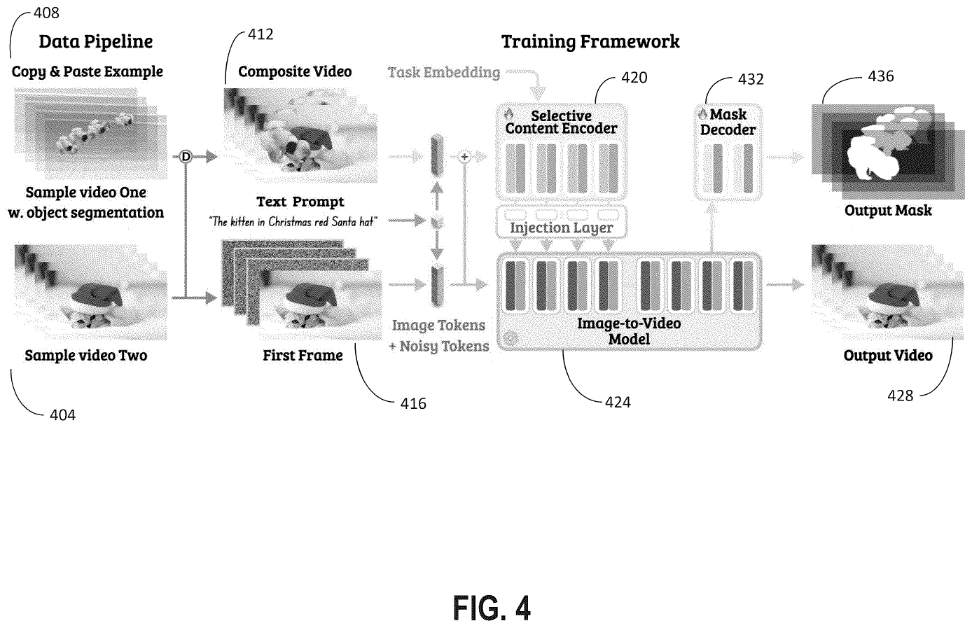

FIG. 4 illustrates an example block diagram of training a media generation system according to aspects of the present disclosure. The media generation system integrates a selective content encoder and mask prediction decoder to a I2V model to preserve the unchanged parts of a media segment and propagate the modified regions of a modified frame of the media segment. The architecture of a SCE is a replicated version of an initial N blocks of the I2V model. In some examples, the architecture of the SCE may be similar to or the same as a ControlNet model. After each encoder block of the SCE, features extracted by the SCE are added to the corresponding features in the I2V model, allowing for a smooth and hierarchical flow of content information. In some examples, the injection layer of the SCE is a one multilayer perceptron with zero initialization (which may also be trained). In a bidirectional information exchange implementation, the features of the I2V model are fused with the to the SCE before the first block. This lets the SCE be aware of the modified regions so that it can selectively encode the information in the unchanged region as intended.

The Mask Prediction Decoder (MPD) estimates the spatial regions of a frame that should be editing, helping the SCE disentangle content that should be modified from content that should remain unmodified. The architecture of the MPD correspond to the last N blocks of the I2V mode. For example, the architecture of the MPD includes the final block along with one multilayer perceptron as the final layer. The MPD receives a latent representation from the penultimate block, which contains rich spatial and temporal information, and processes it through the multilayer perceptron layer to restore the temporal dimension, matching it to the number of video frames. The output of the MPD is trained to match the instance mask of the media segment via a mean squared error loss [symbol] _{MPD}, which guides the MPD to focus on the modified regions of a frame and significantly improves the accuracy of the attention maps.

For example, the data pipeline for training propagation of an object removal editing process includes a first media segment 404 that is unmodified and an object 408 to add to the first media segment 404 generating a modified media segment 412. The inputs to the media generation system include the modified media segment 412 and an original frame 416 from the first media segment 404. The original frame 416 represents a frame in which an editing process was applied to remove the object 408 from the frame. In some instances, the media generation system also receives a context vector associated with the editing process (e.g., represented as a prompt “a kitten in Christmas red Santa hat”). Selective content encoder 420 receives the modified media segment 412 and the original frame 416 and identifies features corresponding to the regions of the original frame 416 that remain unmodified by the removal of the object (e.g., the regions of original frame 416 that do not include the object that was removed). The features are injected into image-to-video model 424 along with the modified media segment 412 and context vector (if included).

In some instances, the selective content encoder defines an image mask for one or more frames of the modified media segment 412 or all of the frames of modified media segment 412 that indicate the regions of the one or more frames (or each frame) that are to remain unchanged when propagating the removal of the object through the modified media segment 412. In other instances, the image-to-video model operates using just the features associated identified by the selective content encoder from original frame 416.

Image-to-video model 424 propagates the editing process through the modified media segment 412 generating a representation of the modified media segment 428 without the object 408, which corresponds to first media segment 404. In some examples, the media generation system compares representation of the modified media segment 428 to the first media segment 404 to determine an accuracy of the propagation of the object removal through the modified media segment 412. The media generation system (or a user thereof) generates metrics from the comparison usable for further training the media generation system such as feedback-based training (e.g., reinforcement learning etc.), determining if training is complete, defining additional training iterations, defining additional training datasets, etc.

Mask Prediction Decoder 432 generates image masks 436 from the output of image-to-video model 424 that predicts regions of the frames that are modified (e.g., corresponding to the locations of object 408). The media generation system uses image masks 436 for further feedback-based training of selective content encoder 420, image-to-video model 424, and/or the like such as reinforcement learning and/or the like. In some instances, the media generation system uses image masks 436 to define accuracy metrics that guide training of the media generation system such as determine how many additional training iterations are needed, when training is complete, etc.

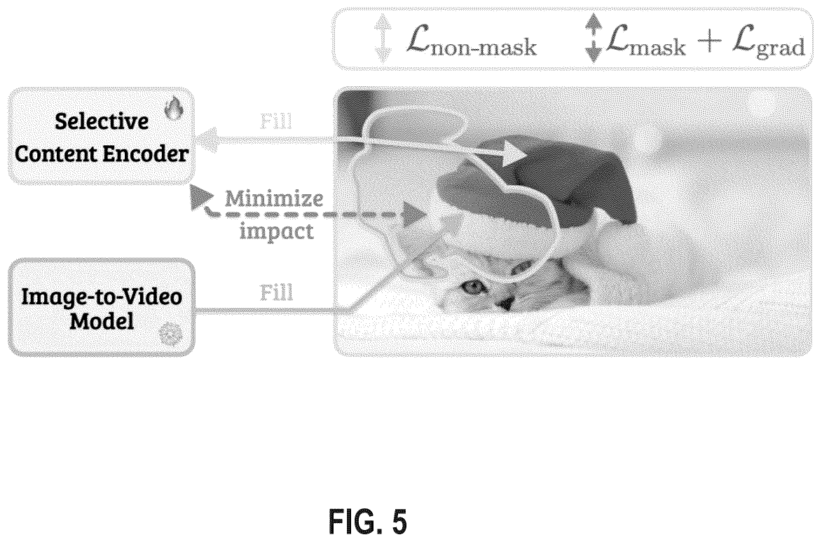

FIG. 5 illustrates an example implementation of region-aware loss within a selective content encoder of a media generation system according to aspects of the present disclosure. During training, the media generation system uses instance segmentation data to ensure that both the edited and unedited regions receive appropriate supervision. A Region-Aware Loss (RA Loss), balances the loss of both regions, even when the edited areas are proportionally small. The image shown is an input image from FIG. 4 illustrating a cat with an object (e.g., a dog) occluding a portion of the cat. The image is edited to remove the object which is then propagated to the other frames of the media segment. The selective content encoder encodes features in regions of the frame that remain unmodified (e.g., portions that do not correspond to the object) as guided by the region-aware loss. The I2V model modifies the frame by filling in the regions of the frame identified by the selective content encoder (e.g., regions of the frame corresponding to the object).

For an input video \hat{V}={\hat{v}₁, \hat{v}₂, . . . , \hat{v}_{T}} and instance-level masks M={m₁, m₂, . . . , m_{T}}, where mₜ∈{0, 1}^{H×W} indicates edited regions in frame \hat{v}ₜ, applying a Gaussian downsampling over the spatial dimensions and repeat over the temporal dimension defines a mask \tilde{m}ₜ that is aligned to the shape of the latent representation of the media segment. The loss is separately computed for the mask and non-mask region, giving:

$${ℒ}_{m a s k} = {t ∼ 𝒰 ( 1 , T )}_{} [ {ℒ}_{d} ( {\tilde{m}}_{t} \cdot {v}_{t}^{o u t} , {\tilde{m}}_{t} \cdot {v}_{t} ) ] and$$

$${ℒ}_{n o n - m a s k} = {t ∼ 𝒰 ( 1 , T )}_{} [ {ℒ}_{d} ( ( 1 - {\tilde{m}}_{t} ) \cdot {v}_{c}^{o u t} , ( 1 - {\tilde{m}}_{t} ) \cdot {v}_{t} ) ]$$

where [symbol] _{d} denotes a diffusion mean square error (MSE) loss that measures the pixel-wise error between the generated frame

$${v}_{t}^{o u t}$$

and ground truth vₜ. To further reduce the SCE's influence on the masked regions, the media generation system defines a gradient loss [symbol] _{grad} that minimizes the effect of the masked area in the encoder's input. Instead of computing second-order gradients, the finite difference is approximated

$$Δ f = \frac{f ( ℰ ( \hat{V} + δ ) ) - f ( ℰ ( \hat{V} ) )}{δ} ,$$

where f(ε(\hat{V})) represents the encoder's feature, and δ is a small perturbation. The gradient loss is defined as: [symbol] _{grad}= [symbol] [\tilde{m}ₜ·∥Δf∥₂]. The RA Loss [symbol] is a weighted sum of all three terms to ensure sufficient supervision on both masked and unmasked areas: [symbol] = [symbol] ₙₒₙ₋ₘₐₛₖ+λ· [symbol] ₘₐₛₖ+β· [symbol] _{grad}+γ· [symbol] _{MPD}

The architecture of the I2V model corresponds to a generative model such as, but not limited to, a diffusion transformer (DiT), convolutional neural networks (e.g., such as U-net, etc.), deep learning networks, generative adversarial networks, combinations thereof, and/or the like.

Example training parameters include the following values. The values for training parameters are exemplary and may be modified to achieve particular implementations: The media generation system trains the I2V on 32, 64, and 128 frames at 12 and 24 frames per second, with a base resolution of 360p. The media generation system trains the SCE and MPD while the I2V model is frozen. In some examples, the media generation system upscales the output of the I2V model using a super-resolution model. In some implementations, the media generation system defines a learning rate of 5e-5 with a cosine-decay scheduler and a linear warmup. In other implementations, the media generation system may use a different learning rate that is fixed or unfixed (e.g., variable throughout training). The media generation system applies an exponential moving average for training stability. A gradient norm threshold of 0.001 prevents training instability. A classifier-free guidance (CFG) value equals 20 and a data augmentation ratio is 0.5/0.375/0.125 for copy-and-paste/mask-and-fill/color fill editing processes. The RA loss, λ is 2.0, β is 1.0, and γ is 1.0.

Once trained, the media generation system processes a classic test set and a challenging test to measure the accuracy of the media generation system. The following tables indicate the performance of the media generation system (referred to below as MGS in the tables) relative to other media generation models. The models were tested using a classic test set and a challenging test set for editing processes (in Table 1), object removal (table 2), and ablation studies (Table 3, which shows the impact of the region aware loss). PSNR (peak signal to noise ratio) measures the consistency outside the edited region and Text Alignment and Consistency metrics measure the edit quality. CLIP (Contrastive Language-Image Pretraining) is another evaluation metric.

TABLE 1

| | Classic Test Set | | | | | Challenging Test Set | | | | |
|---|---|---|---|---|---|---|---|---|---|---|
| | | | | MGS preference % | | | | | MGS Preference % | |
| Method | PSNRₘ↑ | CLIP-T↑ | CLIP-I↑ | Alignment | Quality | PSNRₘ↑ | CLIP-T↑ | CLIP-I↑ | Alignment | Quality |
| InsV2V | 28.999 | 0.3049 | 0.9737 | 60.00 | 60.00 | 28.842 | 0.2906 | 0.9718 | 81.82 | 75.00 |
| AnyV2V | 32.090 | 0.3050 | 0.9676 | 95.56 | 86.67 | 28.338 | 0.3302 | 0.9576 | 97.78 | 95.56 |
| Pika | 32.568 | 0.3226 | 0.9923 | 62.22 | 55.56 | 31.329 | 0.3023 | 0.9886 | 88.89 | 86.67 |
| ReVideo | 31.765 | 0.3196 | 0.9777 | 75.56 | 71.11 | 29.920 | 0.3226 | 0.9798 | 84.44 | 82.22 |
| MGS | 33.837 | 0.3229 | 0.9825 | — | — | 32.163 | 0.3336 | 0.9904 | — | — |

TABLE 2

MGS Preference %

| Method | CLIP-I↑ | Alignment | Quality |
|---|---|---|---|
| SAM + Propainter | 0.9809 | 82.22 | 75.56 |
| ReVideo [30] | 0.9728 | 86.36 | 77.27 |
| MGS | 0.9879 | — | — |

TABLE 3

| Method | CLIP-T↑ | CLIP-I↑ |
|---|---|---|
| w/o MPD | 0.3252 | 0.9834 |
| GenProp (Ours) | 0.3261 | 0.9825 |
| w/o RA Loss | 0.3316 | 0.9872 |

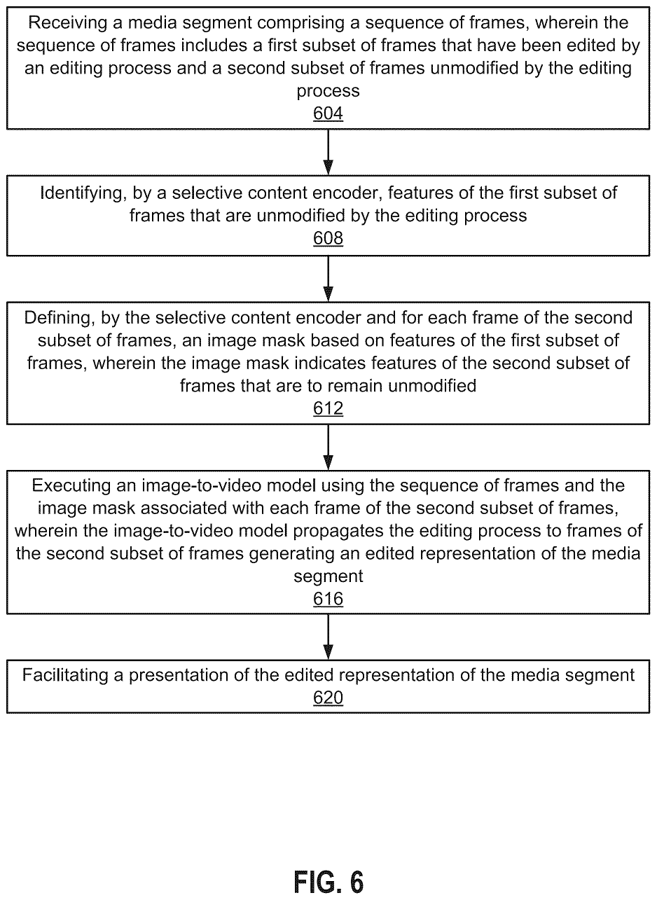

FIG. 6 illustrates a flowchart of an example process for interpolating keyframes to generate interpolated animation frames according to aspects of the present disclosure. A media generation system provides media modification services to users. In some implementations, the media generation system operates as software executing on a computing device or server. In other implementations, the media generation system operates as a hardware platform (e.g., such as an application specific integrated circuit (ASIC), field-programmable gate array (FPGA), special-purpose computer, and/or the like). In still yet other implementations, the media generation system operates as combination of software and hardware. In some examples, the media generation system operates within a distributed environment via one or more computing devices, databases, servers, etc. A user operates media generation system directly (e.g., via an input interface of the media generation system or via a computing device executing the animation system, etc.). Alternatively, or additionally, the user accesses the animation system remotely via a computing device through interfaces exposed by media generation system.

At block 604, the media generation system receives a media segment comprising a sequence of frames. The media segment may include video and/or audio frames. In some instances, the sequence of frames includes a first subset of frames that have been edited by an editing process and a second subset of frames unmodified by the editing process. In other instances, the media generation system executes an editing processing the first subset of frames. Examples of editing processes include, but are not limited to, removing an object, inserting an object, replacing an object and/or background, text-based editing, outpainting, object tracking, combinations thereof, and/or the like. The first subset of frames includes one or more frames positioned at any location within the sequence of frames. If the first subset of frames includes more than one frame, then the frames of the first subset of frames may be contiguous frames within the sequence of frames (e.g., frames positioned next to each other) or non-contiguous frames within the sequence of frames.

At block 608, a selective content encoder of the media generation system identifies features of the first subset of frames that are unmodified by the editing process. The selective content encoder encodes feature of a frame for an image-to-video model (I2V) that generates features. The selective content encoder uses a region-aware loss with weighted gradients to encode features from the regions of a frame that are not subject to the editing process (e.g., remain unmodified after the editing process is applied to the frame). In some alternative implementations, the selective content encoder uses the region-aware loss with weighted gradients to encode features from the regions of a frame that are subject to the editing process (e.g., modified after the editing process is applied to the frame) and does not encode features associated with the unmodified regions of the frame.

At block 612, the media generation system executes an image-to-video model using the sequence of frames. The image-to-video model propagates the editing process applied to first subset of frames to frames of the second subset of frames. In some examples, the media generation system receives a context vector associated with the editing process. The context vector may be an alphanumeric prompt that identifies a context for the editing process that constrains the image-to-video model during propagation of the editing process to the second subset of frames. If the media generation system receives a context vector in association with the media segment or editing process, then the media generation system executes the image-to-video model further using the context vector.

At block 616, the media generation system injects, during execution of the image-to-video model, the features of the first subset of frames into the image-to-video model. Injecting the features of the first subset of frames causes the image-to-video model to preserve portions of the second subset of frames that correspond to the features of the first subset of frames during propagation of the editing process to the second subset of frames. In some examples, the media generation system includes an injection layer between the selective model encoder and the image-to-video model. The injection layer adds the features of the first subset of frames (from the selective content encoder) to features of the second subset of frames (extracted by the image-to-video model) to preserve regions of the second subset of frames that are not subject to the editing process. In some instances, the injection layer is a multilayer perceptron that operates in one direction (e.g., from the selective content encoder to the image-to-video model, etc.) or selectively bidirectionally (e.g., from the selective content encoder to the image-to-video model and/or from the image-to-video model to the selective content encoder, etc.).

At block 620, the media generation system facilitates a presentation of the edited representation of the media segment. In some examples, the media generation system stores the edited media segment in memory for further processing (e.g., such as further editing, transmission, display, etc.). For example, the media generation system receives feedback associated with the edited media segment causing the media generation system to propagate the feedback through the edited media segment generating a new edited media segment. The feedback may be related to the initial editing process to adjust the initial editing process or propagation of the initial editing process through the media segment or related to a new editing process (e.g., a newly edited frame, etc.). In other instances, the media generation system transmits the edited media segment to remote device (e.g., such as a client device, server, database, webhost, etc.).

### Architecture: Pixel Diffusion

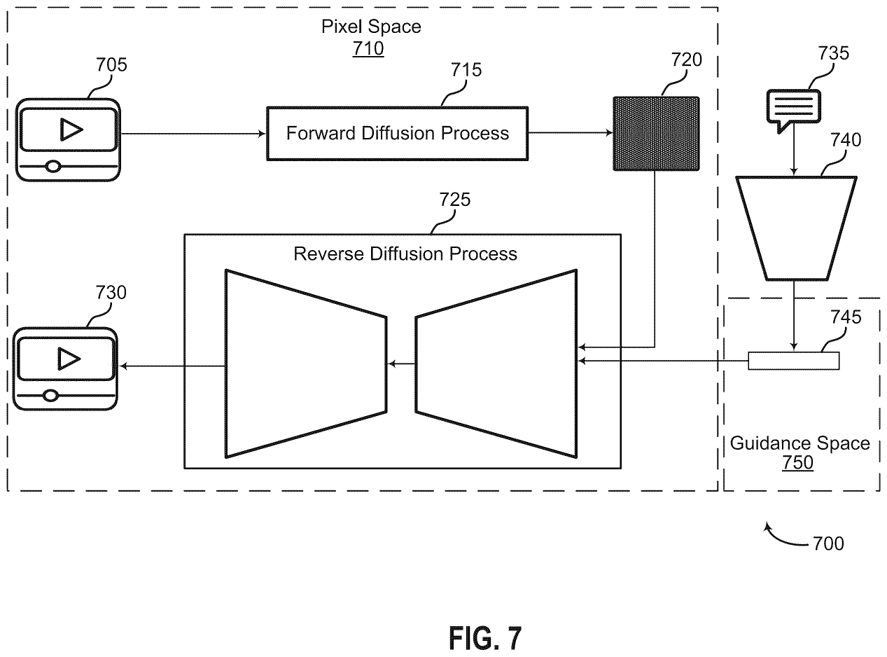

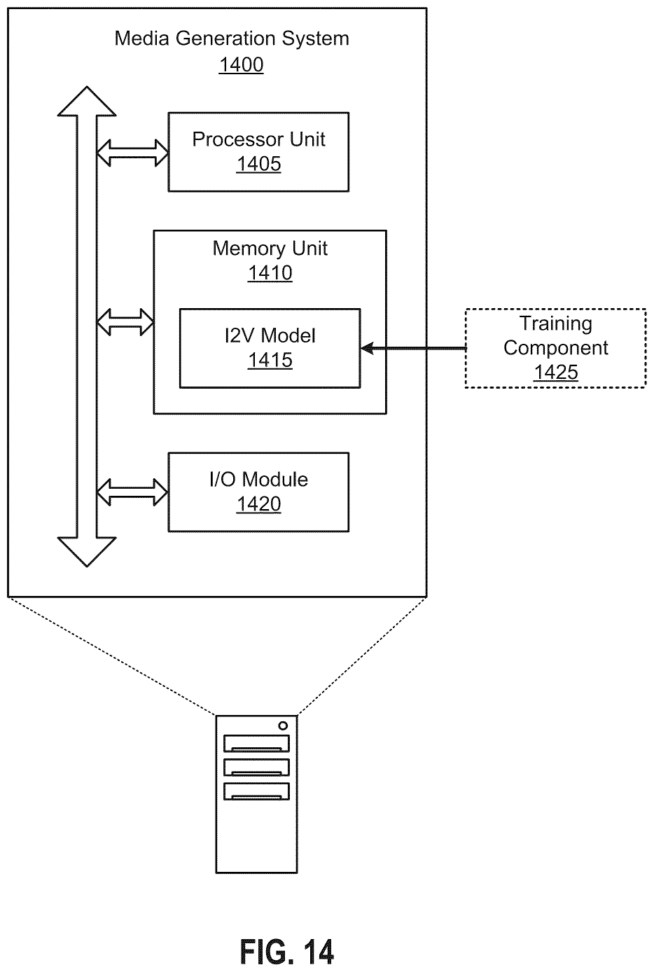

FIG. 7 shows an example of a guided diffusion model 700 according to aspects of the present disclosure. In some examples, guided diffusion model 700 describes the operation and architecture of the I2V model 1415 described with reference to FIG. 14. The guided latent diffusion model 700 depicted in FIG. 7 is an example of, or includes aspects of, a media generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 700 may take an original media item 705 in a pixel space 710 as input and apply forward diffusion process 715 to gradually add noise to the original media item 705 to obtain noisy media item 720 at various noise levels.

Next, a reverse diffusion process 725 (e.g., a U-Net) gradually removes the noise from the noisy media item 720 at the various noise levels to obtain an output media item 730. In some cases, an output media item 730 is created from each of the various noise levels. The output media item 730 can be compared to the original media item 705 to train the reverse diffusion process 725.

The reverse diffusion process 725 can also be guided based on a text prompt 735, or another guidance prompt, such as an image, a layout, a segmentation map, etc. The text prompt 735 can be encoded using a text encoder 740 (e.g., a multimodal encoder) to obtain guidance features 745 in guidance space 750. The guidance features 745 can be combined with the noisy media item 720 at one or more layers of the reverse diffusion process 725 to ensure that the output media item 730 includes content described by the text prompt 735. For example, guidance features 745 can be combined with the noisy features using a cross-attention block within the reverse diffusion process 725.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item.

### Architecture: U-Net

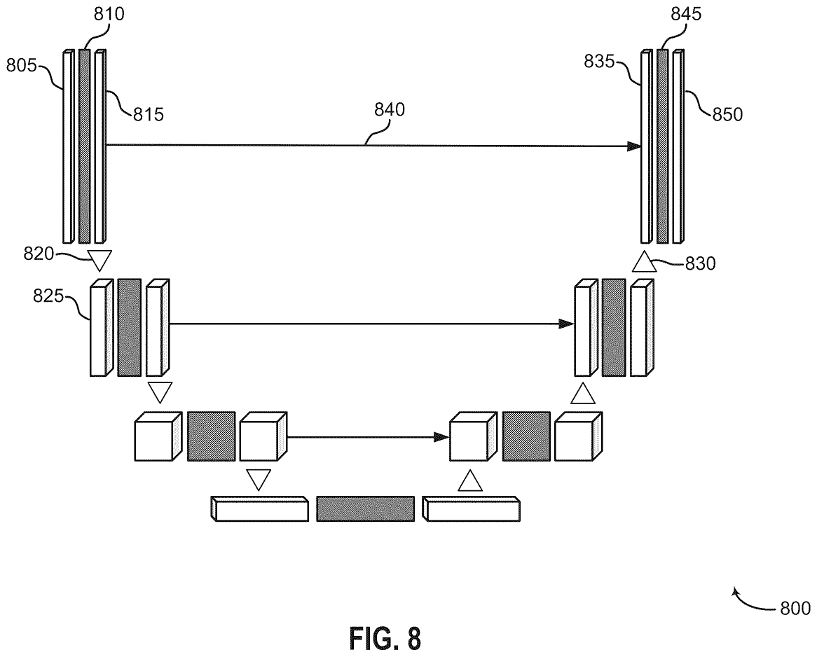

FIG. 8 shows an example of a U-Net 800 according to aspects of the present disclosure. In some examples, U-Net 800 is an example of the component that performs the reverse diffusion process 725 of guided diffusion model 700 described with reference to FIG. 7 and includes architectural elements of I2V model 1415 described with reference to FIG. 14. The U-Net 800 depicted in FIG. 8 is an example of, or includes aspects of, the architecture used within the reverse diffusion process described with reference to FIG. 7.

In some examples, diffusion models are based on a neural network architecture known as a U-Net. The U-Net 800 takes input features 805 having an initial resolution and an initial number of channels and processes the input features 805 using an initial neural network layer 810 (e.g., a convolutional network layer) to produce intermediate features 815. The intermediate features 815 are then down-sampled using a down-sampling layer 820 such that down-sampled features 825 features have a resolution less than the initial resolution and a number of channels greater than the initial number of channels.

This process is repeated multiple times, and then the process is reversed. That is, the down-sampled features 825 are up-sampled using up-sampling process 830 to obtain up-sampled features 835. The up-sampled features 835 can be combined with intermediate features 815 having the same resolution and number of channels via a skip connection 840. These inputs are processed using a final neural network layer 845 to produce output features 850. In some cases, the output features 850 have the same resolution as the initial resolution and the same number of channels as the initial number of channels.

In some cases, U-Net 800 takes additional input features to produce conditionally generated output. For example, the additional input features could include a vector representation of an input prompt. The additional input features can be combined with the intermediate features 815 within the neural network at one or more layers. For example, a cross-attention module can be used to combine the additional input features and the intermediate features 815.

### Inference: Conditional Generation

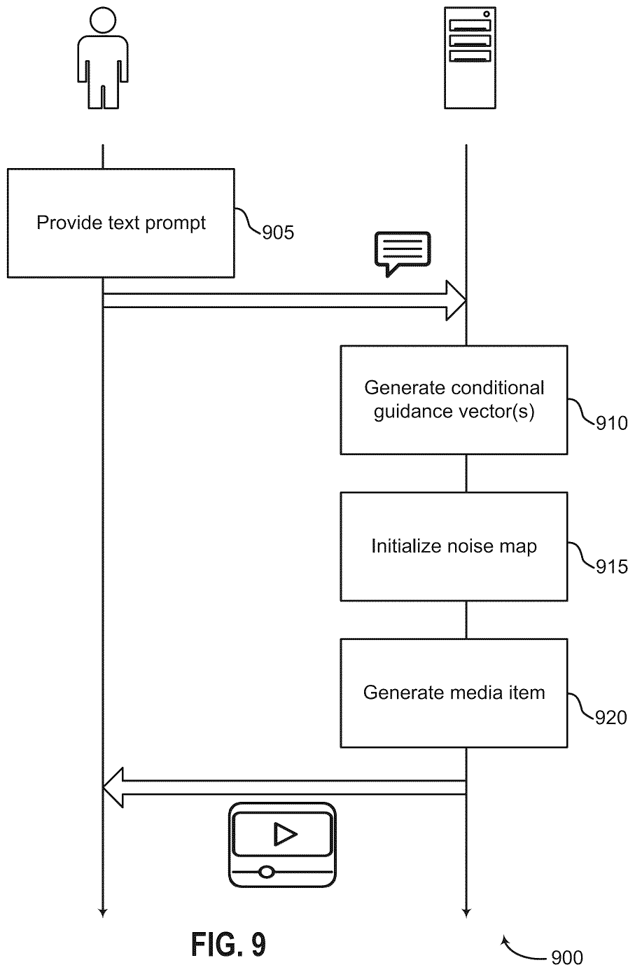

FIG. 9 shows an example of a method 900 for conditional media generation according to aspects of the present disclosure. In some examples, method 900 describes an operation of I2V model 1415 described with reference to FIG. 14 such as an application of the guided diffusion model 700 described with reference to FIG. 7. In some examples, these operations are performed by a system including a processor executing a set of codes to control functional elements of an apparatus such as the media generation model described in FIG. 7.

Additionally or alternatively, steps of the method 900 may be performed using special-purpose hardware. Generally, these operations are performed according to the methods and processes described in accordance with aspects of the present disclosure. In some cases, the operations described herein are composed of various substeps, or are performed in conjunction with other operations.

At operation 905, a user provides a text prompt describing content to be included in a generated media item. For example, a user may provide the prompt “a person playing with a cat.” In some examples, guidance can be provided in a form other than text, such as via an image, a sketch, or a layout.

At operation 910, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 915, a noise map is initialized that includes random noise. The noise map may be in a pixel space or a latent space. By initializing a media item with random noise, different variations of a media item including the content described by the conditional guidance can be generated.

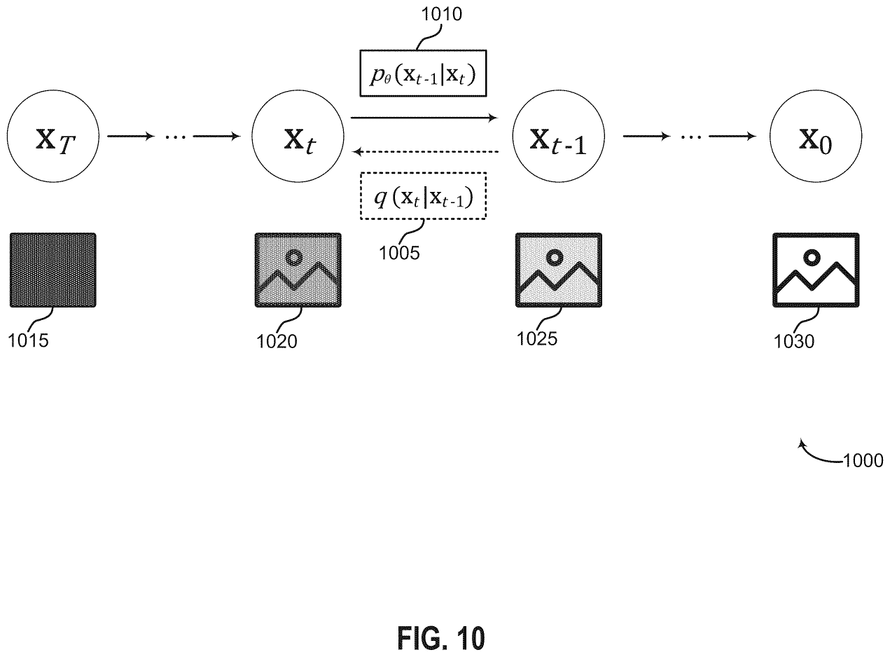

At operation 920, the system generates a media item based on the noise map and the conditional guidance vector. For example, the media item may be generated using a reverse diffusion process as described with reference to FIG. 10.

### Inference: Reverse Diffusion

FIG. 10 shows a diffusion process 1000 according to aspects of the present disclosure. In some examples, diffusion process 1000 describes an operation of I2V model 1415 described with reference to FIG. 14, such as the reverse diffusion process 725 of guided diffusion model 700 described with reference to FIG. 7.

As described above with reference to FIG. 7 using a diffusion model can involve both a forward diffusion process 1005 for adding noise to a media item (or features in a latent space) and a reverse diffusion process 1010 for denoising the media item (or features) to obtain a denoised media item. The forward diffusion process 805 can be represented as q(xₜ|xₜ₋₁), and the reverse diffusion process 1010 can be represented as p(xₜ₋₁|xₜ). In some cases, the forward diffusion process 1005 is used during training to generate media items with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy media item 1015 and denoises the data to obtain the p(xₜ₋₁|xₜ). At each step t−1, the reverse diffusion process 1010 takes xₜ, such as first intermediate media item 1020, and t as input. Here, t represents a step in the sequence of transitions associated with different noise levels, The reverse diffusion process 1010 outputs xₜ₋₁, such as second intermediate media item 1025 iteratively until x_{T} reverts back to x₀, the original media item 1030. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

### Training: Machine Learning

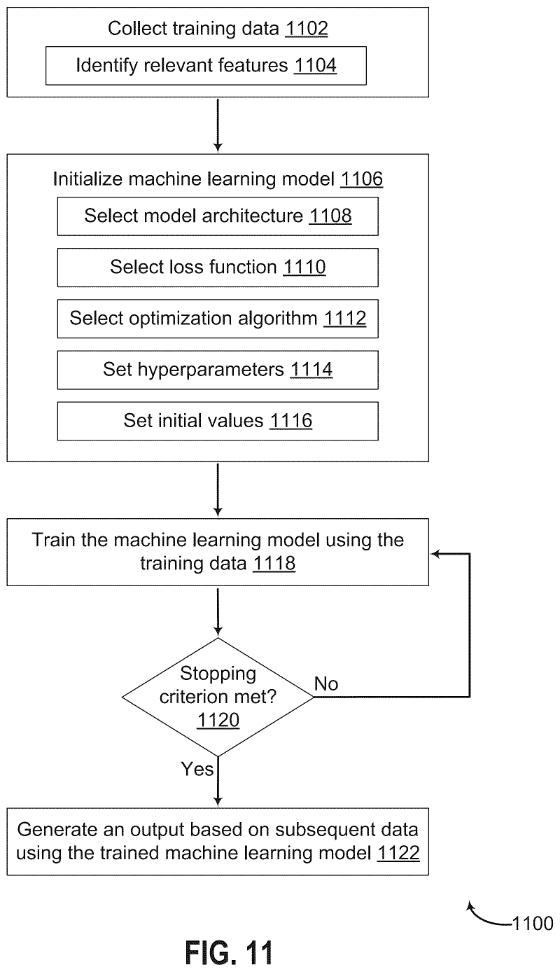

FIG. 11 is a flow diagram depicting an algorithm as a step-by-step procedure 1100 in an example implementation of operations performable for training a machine-learning model. In some embodiments, the procedure 1100 describes an operation of the training component 1425 described for configuring I2V model 1415 as described with reference to FIG. 14. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1116) examples of which includes initializing weights and biases of nodes to improve efficiency in training and computational resources consumption as part of training. Hyperparameters are also set (block 1114) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

### Training: Diffusion Training

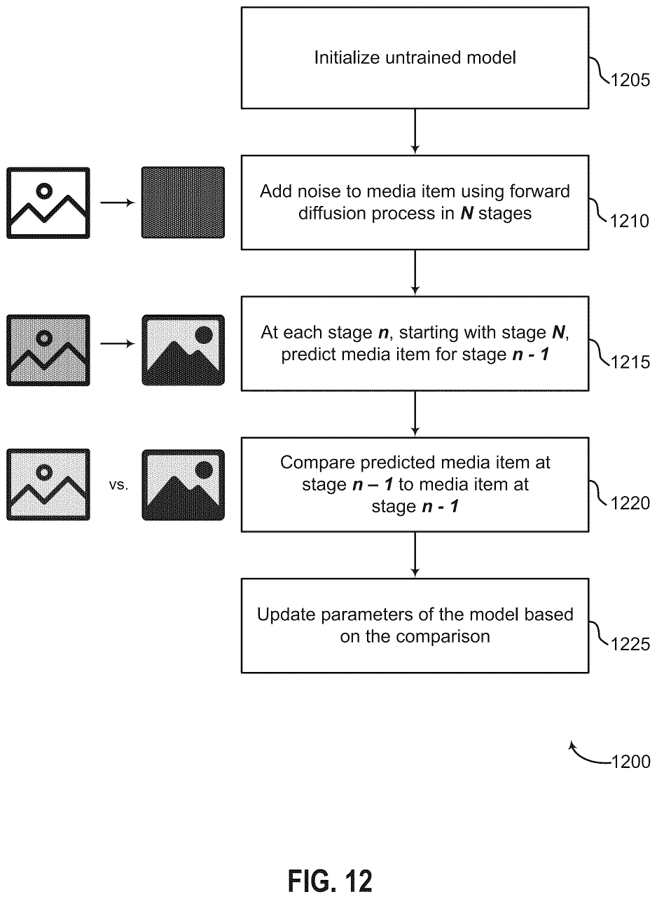

FIG. 12 shows an example of a method 1200 for training a diffusion model according to aspects of the present disclosure. In some embodiments, the method 1200 describes an operation of the training component 1425 described for configuring I2V model 1415 as described with reference to FIG. 14. The method 1200 represents an example for training a reverse diffusion process as described above with reference to FIG. 10. In some examples, these operations are performed by a system including a processor executing a set of codes to control functional elements of an apparatus, such as the guided diffusion model described in FIG. 7.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 1215, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1225, the system updates parameters of the model based on the comparison. For example, parameters of a U-Net may be updated using gradient descent. Time-dependent parameters of the Gaussian transitions can also be learned.

### System: Computing Device

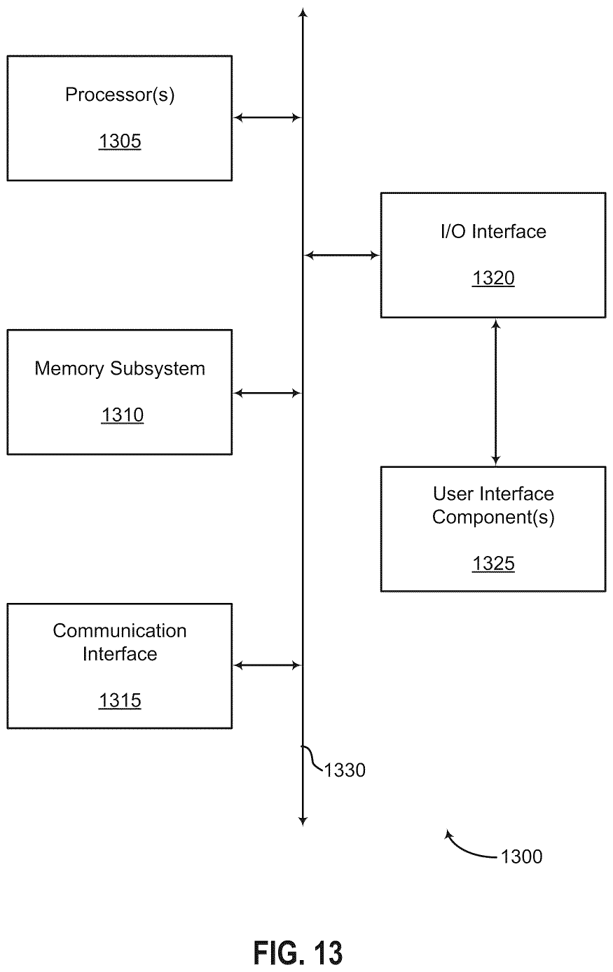

FIG. 13 shows an example of a computing device 1300 according to aspects of the present disclosure. The computing device 1300 may be an example of the media generation system 1400 described with reference to FIG. 14. In one aspect, computing device 1300 includes processor(s) 1305, memory subsystem 1310, communication interface 1115, I/O interface 1320, user interface component(s) 1325, and channel 1330.

In some embodiments, computing device 1300 is an example of, or includes aspects of, the media generation model of FIG. 7. In some embodiments, computing device 1300 includes one or more processors 1305 that can execute instructions stored in memory subsystem 1310 to perform media generation.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

### Media Generation System

FIG. 14 shows an example of a media generation system 1400 according to aspects of the present disclosure. Media generation system 1400 may include an example of, or aspects of, the guided diffusion model described with reference to FIG. 7 and the U-Net described with reference to FIG. 8. In some embodiments, media generation system 1400 includes processor unit 1405, memory unit 1410, I2V model 1415, I/O module 1420, and training component 1425. Training component 1425 updates parameters of I2V model 1415 stored in memory unit 1410. In some examples, training component 1425 is located outside the media generation system 1400.

Processor unit 1405 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1405 is configured to operate a memory array using a memory controller. In other cases, a memory controller is integrated into processor unit 1405. In some cases, processor unit 1405 is configured to execute computer-readable instructions stored in memory unit 1410 to perform various functions. In some aspects, processor unit 1405 includes special purpose components for modem processing, baseband processing, digital signal processing, or transmission processing. According to some aspects, processor unit 1405 comprises one or more processors described with reference to FIG. 13.

Memory unit 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1405 to perform various functions described herein.

In some cases, memory unit 1410 includes a basic input/output system (BIOS) that controls basic hardware or software operations, such as an interaction with peripheral components or devices. In some cases, memory unit 1410 includes a memory controller that operates memory cells of memory unit 1410. For example, the memory controller may include a row decoder, column decoder, or both. In some cases, memory cells within memory unit 1410 store information in the form of a logical state. According to some aspects, memory unit 1410 is an example of the memory subsystem 1310 described with reference to FIG. 13.

According to some aspects, media generation system 1400 uses one or more processors of processor unit 1405 to execute instructions stored in memory unit 1410 to perform functions described herein. For example, media generation system 1400 may receive a media segment comprising a first set of frames that have been edited through execution of an editing process and a second set of frames that have not been edited. Media generation system, using I2V model 1415, propagates the editing process applied to the first set of frames to the second set of frames generating a new media segment. I2V model 1415 propagates the editing process using a selective content encoder that identifies features of the first set of frames that are unmodified by the editing process and injects the features into I2V model 1415. I2V model 1415 then generates a modified version of the second set of frames that incorporates the editing process applied to the first set of claims while preserving the portions of the frames that should not be modified (based on the injected features).

The memory unit 1410 may include I2V model 1415 trained to generate a scene graph by generating a representation of one or more objects oriented within a two-dimensional environment of the scene graph and subdividing the two-dimensional environment into one or more subparts. For example, after training, I2V model 1415 may perform inferencing operations as described with reference to FIGS. 9 and 10 to generate a representation of one or more objects oriented within a two-dimensional environment of the scene graph and subdividing the two-dimensional environment into one or more subparts.

In some embodiments, I2V model 1415 is an artificial neural network (ANN) such as the guided diffusion model described with reference to FIG. 7 and the U-Net described with reference to FIG. 8. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of I2V model 1415 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1425 may train I2V model 1415. For example, parameters of I2V model 1415 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 11 and 12). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, I2V model 1415 can be used to make predictions on new, unseen data (i.e., during inference).

I/O module 1420 receives inputs from and transmits outputs of the media generation system 1400 to other devices or users. For example, I/O module 1420 receives inputs for I2V model 1415 and transmits outputs of I2V model 1415. According to some aspects, I/O module 1420 is an example of the I/O interface 1320 described with reference to FIG. 13.

The following examples illustrate various aspects of the present disclosure. As used below, any reference to a series of examples is to be understood as a reference to each of those examples disjunctively (e.g., “Examples 1-4” is to be understood as “Examples 1, 2, 4, or 4”).

Example 1 is a method comprising: receiving a media segment comprising a sequence of frames, wherein the sequence of frames includes a first subset of frames that have been edited by an editing process and a second subset of frames unmodified by the editing process; identifying, by a selective content encoder, features of the first subset of frames that are unmodified by the editing process; executing an image-to-video model using the sequence of frames, wherein the image-to-video model propagates the editing process to frames of the second subset of frames; injecting, during execution of the image-to-video model, the features of the first subset of frames into the image-to-video model, wherein injecting the features of the first subset of frames cause the image-to-video model to preserve portions of the second subset of frames that correspond to the features of the first subset of frames; and facilitating a presentation of the edited representation of the media segment.

Example 2 is the method of example(s) 1, wherein the first subset of frames includes two or more frames.

Example 3 is the method of example(s) 1, wherein the first subset of frames includes the first frame in the sequence of frames.

Example 4 is the method of example(s) 1, further comprising: receiving a context vector associated with the editing process, wherein executing the image-to-video model further uses the context vector, and wherein the context vector constrains a generative process of the image-to-video model.

Example 5 is the method of example(s) 1, wherein the editing process includes removing an object from the first subset of frames, and wherein the image-to-video model propagates the editing process by removing the object from at least one frame of the second subset of frames.

Example 6 is the method of example(s) 1, wherein the editing process includes inserting an object to the first subset of frames, and wherein the image-to-video model propagates the editing process by inserting the object to at least one frame of the second subset of frames.

Example 7 is the method of example(s) 1, wherein the editing process tags pixels of the first subset of frames associated with a context, and wherein the image-to-video model propagates the editing process by tagging pixels of the second subset of frames that are associated with the context.

Example 8 is a system comprising: one or more processors; and a non-transitory computer-readable medium storing instructions that when executed by the one or more processors, cause the one or more processors to perform operations including: receiving a media segment comprising a sequence of frames; executing an editing process on a first subset of frames of the sequence of frames, wherein the editing process modifies one or more pixels of the first subset of frames, and wherein a second subset of frames of the sequence of frames are unmodified by the editing process; identifying, by a selective content encoder, features of the first subset of frames that are unmodified by the editing process; executing an image-to-video model using the sequence of frames, wherein the image-to-video model propagates the editing process to frames of the second subset of frames; injecting, during execution of the image-to-video model, the features of the first subset of frames into the image-to-video model, wherein injecting the features of the first subset of frames cause the image-to-video model to preserve portions of the second subset of frames that correspond to the features of the first subset of frames; and facilitating a presentation of the edited representation of the media segment.

Example 9 is the system of example(s) 8, wherein the first subset of frames includes two or more frames.

Example 10 is the system of example(s) 8, wherein the first subset of frames includes the first frame in the sequence of frames.

Example 11 is the system of example(s) 8, wherein the operations further include: receiving a context vector associated with the editing process, wherein executing the image-to-video model further uses the context vector, and wherein the context vector constrains a generative process of the image-to-video model.

Example 12 is the system of example(s) 8, wherein the editing process includes removing an object from the first subset of frames, and wherein the image-to-video model propagates the editing process by removing the object from at least one frame of the second subset of frames.

Example 13 is the system of example(s) 8, wherein the editing process includes inserting an object to the first subset of frames, and wherein the image-to-video model propagates the editing process by inserting the object to at least one frame of the second subset of frames.

Example 14 is the system of example(s) 8, wherein the editing process tags pixels of the first subset of frames associated with a context, and wherein the image-to-video model propagates the editing process by tagging pixels of the second subset of frames that are associated with the context.

Example 15 is a non-transitory computer-readable medium storing instructions that when executed by one or more processors, cause the one or more processors to perform operations including: receiving a media segment comprising a sequence of frames, wherein the sequence of frames includes a first subset of frames that have been edited by an editing process and a second subset of frames unmodified by the editing process; identifying, by a selective content encoder, features of the first subset of frames that are unmodified by the editing process; executing an image-to-video model using the sequence of frames, wherein the image-to-video model propagates the editing process to frames of the second subset of frames; injecting, during execution of the image-to-video model, the features of the first subset of frames into the image-to-video model, wherein injecting the features of the first subset of frames cause the image-to-video model to preserve portions of the second subset of frames that correspond to the features of the first subset of frames; and facilitating a presentation of the edited representation of the media segment.

Example 16 is the non-transitory computer-readable medium of example(s) 15, wherein the first subset of frames includes two or more frames.

Example 17 is the non-transitory computer-readable medium of example(s) 15, wherein the first subset of frames includes the first frame in the sequence of frames.

Example 18 is the non-transitory computer-readable medium of example(s) 15, wherein the editing process includes removing an object from the first subset of frames, and wherein the image-to-video model propagates the editing process by removing the object from at least one frame of the second subset of frames.

Example 19 is the non-transitory computer-readable medium of example(s) 15, wherein the editing process includes inserting an object to the first subset of frames, and wherein the image-to-video model propagates the editing process by inserting the object to at least one frame of the second subset of frames.

Example 20 is the non-transitory computer-readable medium of example(s) 15 wherein the editing process tags pixels of the first subset of frames associated with a context, and wherein the image-to-video model propagates the editing process by tagging pixels of the second subset of frames that are associated with the context.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to further limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined.

1. A method comprising:
receiving a media segment comprising a sequence of frames, wherein a first subset of frames of the sequence of frames have been modified by an editing process;
identifying, by a selective content encoder, features of the first subset of frames that are unmodified by the editing process;
executing an image-to-video model using the sequence of frames and the features, wherein image-to-video model generates an edited representation of the media segment by propagating the editing process to remaining frames of the sequence of frames while preserving portions of the remaining frames that correspond to the features; and
facilitating a presentation of the edited representation of the media segment.

2. The method of claim 1, wherein the first subset of frames includes two or more frames.

3. The method of claim 1, wherein the first subset of frames includes the first frame in the sequence of frames.

4. The method of claim 1, further comprising:
receiving a context vector associated with the editing process, wherein executing the image-to-video model further uses the context vector, and wherein the context vector constrains a generative process of the image-to-video model.

5. The method of claim 1, wherein the editing process includes removing an object from the first subset of frames, and wherein the image-to-video model propagates the editing process by removing the object from at least one frame of a second subset of frames.

6. The method of claim 1, wherein the editing process includes inserting an object to the first subset of frames, and wherein the image-to-video model propagates the editing process by inserting the object to at least one frame of a second subset of frames.

7. The method of claim 1, wherein the editing process tags pixels of the first subset of frames associated with a context, and wherein the image-to-video model propagates the editing process by tagging pixels of a second subset of frames that are associated with the context.

8. A system comprising:
one or more processors; and
a non-transitory computer-readable medium storing instructions that when executed by the one or more processors, cause the one or more processors to perform operations including:
receiving a media segment comprising a sequence of frames, wherein a first subset of frames of the sequence of frames have been modified by an editing process;
identifying, by a selective content encoder, features of the first subset of frames that are unmodified by the editing process;
executing an image-to-video model using the sequence of frames and the features, wherein image-to-video model generates an edited representation of the media segment by propagating the editing process to remaining frames of the sequence of frames while preserving portions of the remaining frames that correspond to the features; and
facilitating a presentation of the edited representation of the media segment.

9. The system of claim 8, wherein the first subset of frames includes two or more frames.

10. The system of claim 8, wherein the first subset of frames includes the first frame in the sequence of frames.

11. The system of claim 8, wherein the operations further include:
receiving a context vector associated with the editing process, wherein executing the image-to-video model further uses the context vector, and wherein the context vector constrains a generative process of the image-to-video model.

12. The system of claim 8, wherein the editing process includes removing an object from the first subset of frames, and wherein the image-to-video model propagates the editing process by removing the object from at least one frame of a second subset of frames.

13. The system of claim 8, wherein the editing process includes inserting an object to the first subset of frames, and wherein the image-to-video model propagates the editing process by inserting the object to at least one frame of a second subset of frames.

14. The system of claim 8, wherein the editing process tags pixels of the first subset of frames associated with a context, and wherein the image-to-video model propagates the editing process by tagging pixels of a second subset of frames that are associated with the context.

15. A non-transitory computer-readable medium storing instructions that when executed by one or more processors, cause the one or more processors to perform operations including:
receiving a media segment comprising a sequence of frames, wherein a first subset of frames of the sequence of frames have been modified by an editing process;
identifying, by a selective content encoder, features of the first subset of frames that are unmodified by the editing process;
executing an image-to-video model using the sequence of frames and the features, wherein image-to-video model generates an edited representation of the media segment by propagating the editing process to remaining frames of the sequence of frames while preserving portions of the remaining frames that correspond to the features; and
facilitating a presentation of the edited representation of the media segment.

16. The non-transitory computer-readable medium of claim 15, wherein the first subset of frames includes two or more frames.

17. The non-transitory computer-readable medium of claim 15, wherein the first subset of frames includes the first frame in the sequence of frames.

18. The non-transitory computer-readable medium of claim 15, wherein the editing process includes removing an object from the first subset of frames, and wherein the image-to-video model propagates the editing process by removing the object from at least one frame of a second subset of frames.

19. The non-transitory computer-readable medium of claim 15, wherein the editing process includes inserting an object to the first subset of frames, and wherein the image-to-video model propagates the editing process by inserting the object to at least one frame of a second subset of frames.

20. The non-transitory computer-readable medium of claim 15 wherein the editing process tags pixels of the first subset of frames associated with a context, and wherein the image-to-video model propagates the editing process by tagging pixels of a second subset of frames that are associated with the context.
